(19) United States
(12) Patent Application Publication
(10) Pub. No.: US 2013/0195179 A1
(43) Pub. Date: Aug. 1, 2013

(54) IMAGE PROCESSOR

(71) Applicants: Toshimitsu Tatsuka, Osaka (JP); Hiromu Hasegawa, Osaka (JP); Takeaki Komuro, Osaka (JP); Masato Yamada, Osaka (JP)

(72) Inventors: Toshimitsu Tatsuka, Osaka (JP); Hiromu Hasegawa, Osaka (JP); Takeaki Komuro, Osaka (JP); Masato Yamada, Osaka (JP)

(73) Assignee: MegaChips Corporation, Osaka-shi (JP)

(21) Appl. No.: 13/877,068

(22) PCT Filed: Aug. 26, 2011
(86) PCT No.: PCT/JP2011/069340

§ 371 Date: Mar. 29, 2013

(30) Foreign Application Priority Data
Nov. 19, 2010 (JP) 2010-258712

(51) Int. Cl. H04N 7/26

(52) U.S. Cl. CPC H04N 19/0006
USPC 375/240.03

(57) ABSTRACT

An image processor includes an encoder that performs encoding including quantization on an image signal and a controller that controls a quantization parameter in the quantization. The controller determines a quantization parameter of a currently target macroblock, based on a difference between a target amount of code for a specified number of macroblocks and an amount of code generated for a predetermined number of macroblocks processed immediately before. The controller variably sets the specified number.

### FIELD OF THE INVENTION

The present invention relates to image processors, and more particularly, to an algorithm for code amount control in moving image compression.

### DESCRIPTION OF THE BACKGROUND ART

Code amount control is a technique to optimize an image quality by controlling a generated amount of code (see, for example, Patent Literatures 1 and 2 below). In existing code amount control algorithms, code amount control is generally performed by a GOP (Group Of Picture) unit or a frame unit. In code amount control by a frame unit, for example, an amount of code allotted for one frame is calculated, and a quantization parameter for each macroblock within the frame is controlled so as not to exceed this amount of code.

### CITATION LIST

### Patent Literature

Patent Literature 1: JP10-215460A

Patent Literature 2: JP10-243399A

### SUMMARY OF THE INVENTION

### Problems to be Solved by the Invention

Code amount control targeting at an amount of code by a GOP unit or a frame unit achieves improvement in an image quality, since an average section to obtain a target constant bit rate is long, and therefore a relatively large value is allowed for a peak value of a code amount. However, a long average section means a long buffering time, resulting in a large delay amount in encoding. Thus while code amount control performed by a GOP unit or a frame unit is suitable for image reproduction under a loose delay limit, it is not suitable for image reproduction under a rigid delay limit. It is therefore preferable that a delay amount takes precedence over an image quality in image reproduction under a rigid delay limit. In image reproduction under a loose delay limit, in contrast, it is preferable that control is performed with an amount of code by a GOP unit or a frame unit as a target amount of code, so as to give precedence to the image quality over the delay amount.

The present invention has been made in view of such situation, and is directed to obtaining an image processor that achieves adequate adjustment of an image quality and a delay amount depending on conditions of image reproduction.

### Means to solve the Problems

An image processor according to a first aspect of the present invention includes an encoder that performs encoding including quantization on an image signal and a controller that controls a quantization parameter in the quantization. The controller determines a quantization parameter of a currently target macroblock, based on a difference between a target amount of code for a specified number of macroblocks and an amount of code generated for a predetermined number of macroblocks processed immediately before. The controller variably sets the specified number.

In the image processor according to the first aspect, the controller determines the quantization parameter of the currently target macroblock, based on a difference between the target amount of code for the specified number of macroblocks and the amount of code generated for the predetermined number of macroblocks processed immediately before. The controller also variably sets the specified number. Consequently, in image reproduction under a rigid delay limit, the controller sets the specified number at a relatively small value, so as to give precedence to the delay amount over the image quality. In image reproduction under a loose delay limit, the controller sets the specified number at a relatively large value, so as to give precedence to the image quality over the delay amount. As a result, adequate adjustment of the image quality and the delay amount depending on conditions of image reproduction is achieved.

An image processor according to a second aspect of the present invention is the image processor according to the first aspect, wherein the controller determines the quantization parameter of the currently target macroblock as an increase or decrease from a reference value, and determines the increase or decrease, based on a difference between the target amount of code for the specified number of macroblocks and an amount of code generated for the specified number of macroblocks processed immediately before.

In the image processor according to the second aspect, the controller determines the quantization parameter of the currently target macroblock as the increase or decrease from the reference value. The controller further determines the increase or decrease, based on the difference between the target amount of code for the specified number of macroblocks and the amount of code generated for this specified number of macroblocks processed immediately before. In this way, determining the increase or decrease based on the difference between the target amount of code for the specified number of macroblocks and the amount of code generated for the specified number of macroblocks processed immediately before achieves adequate determination of the quantization parameter of the currently target macroblock depending on conditions of image reproduction.

An image processor according to a third aspect of the present invention is the image processor according to the second aspect, wherein the controller, if the amount of code generated for the specified number of macroblocks processed immediately before exceeds a predetermined threshold to be set depending on a maximum allowable amount of code, sets the quantization parameter of the currently target macroblock at a value obtained by adding a constant value to a quantization parameter of a previously processed macroblock.

In the image processor according to the third aspect, the controller, if the amount of code generated for the specified number of macroblocks processed immediately before exceeds the predetermined threshold to be set depending on the maximum allowable amount of code, sets the quantization parameter of the currently target macroblock at the value obtained by adding the constant value to the quantization parameter of the previously processed macroblock. In this way, exceptional processing to forcibly set the quantization parameter at a larger value when the generated amount of code exceeds the threshold helps to prevent the generated amount of code from exceeding the maximum allowable amount of code.

An image processor according to a fourth aspect of the present invention is the image processor according to the first aspect, wherein the controller includes a first processing unit that obtains a generated amount of code used for a first predetermined number of immediately preceding macroblocks, a second processing unit that obtains an allowable amount of code available for a third predetermined number of immediately subsequent macroblocks including the currently target macroblock, based on the target amount of code for a second predetermined number, which is the specified number, of macroblocks and the generated amount of code obtained by the first processing unit, a third processing unit that obtains an expected amount of code expected to be used for the third predetermined number of macroblocks, and a fourth processing unit that determines the quantization parameter of the currently target macroblock, based on the allowable amount of code obtained by the second processing unit and the expected amount of code obtained by the third processing unit.

In the image processor according to the fourth aspect, the first processing unit obtains the generated amount of code used for the first predetermined number of immediate preceding macroblocks. The second processing unit obtains the allowable amount of code available for the third predetermined number of immediately subsequent macroblock including the currently target macroblock, based on the target amount of code for the second predetermined number, which is the specified number, of macroblocks and the generated amount of code obtained by the first processing unit. The third processing unit obtains the expected amount of code expected to be used for the third predetermined number of macroblocks. The fourth processing unit determines the quantization parameter of the currently target macroblock, based on the allowable amount of code obtained by the second processing unit and the expected amount of code obtained by the third processing unit. In this way, determining the quantization parameter of the currently target macroblock based on the target amount of code for the second predetermined number, which is the specified number, of macroblocks achieves adequate determination of the quantization parameter of the currently target macroblock depending on conditions of image reproduction.

### Effects of the Invention

The present invention achieves adequate adjustment of an image quality and a delay amount depending on conditions of image reproduction.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a diagram illustrating an example of encoding by a macroblock unit.

FIG. 2 is a block diagram illustrating a configuration of an image processor according to Embodiment 1 of the present invention.

FIG. 3 is a block diagram illustrating an example of a configuration of a controller illustrated in FIG. 2.

FIG. 4 is a diagram illustrating an example of how an increase or decrease is determined.

FIG. 5 is a diagram illustrating an example of how the increase or decrease is determined.

FIG. 6 is a diagram illustrating an example of how the increase or decrease is determined.

FIG. 7 is a block diagram illustrating a configuration of an image processor according to Embodiment 2 of the present invention.

FIG. 8 is a block diagram illustrating an example of the configuration of a controller illustrated in FIG. 7.

FIG. 9 is a block diagram illustrating an example of the configuration of the third processing unit illustrated in FIG. 8.

FIG. 10 is a diagram illustrating a first example of parameter sets stored in a memory illustrated in FIG. 9.

FIG. 11 is a diagram illustrating a second example of the parameter sets stored in the memory illustrated in FIG. 9.

FIG. 12 is a flow chart illustrating how an attribute value is determined.

FIG. 13 is a diagram illustrating an example of how a fourth processing unit selects a parameter set.

### DESCRIPTION OF THE INVENTION

Preferred embodiments of the present invention are described in detail below referring to the drawings. It should be noted that identical reference numerals throughout the drawings indicate identical or equivalent elements.

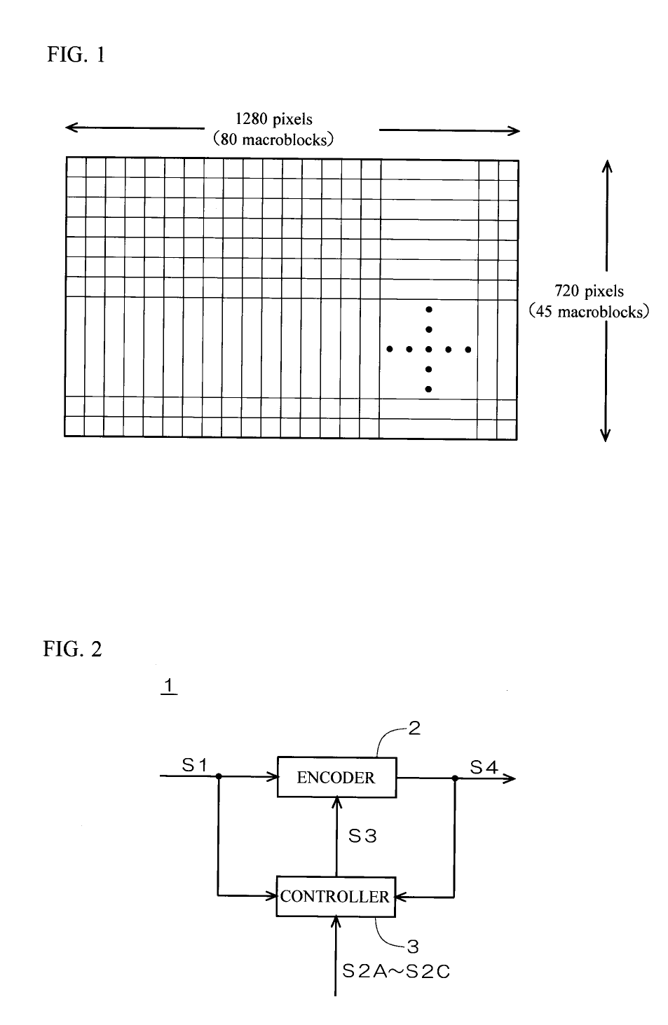

FIG. 1 is a diagram illustrating an example of encoding by a macroblock unit. FIG. 1 illustrates an example of an image of one frame having 1280 pixels in row (horizontally) and 720 pixels in column (vertically). One frame is divided into macroblocks for each 16 pixels in row and for each 16 pixels in column. Thus one frame is divided into 80 macroblocks in row and 45 macroblocks in column. A group of 80 macroblocks equivalent of one row is referred to as macroblock line.

### Embodiment 1

FIG. 2 is a block diagram illustrating a configuration of an image processor 1 according to Embodiment 1 of the present invention. As illustrated in FIG. 2, the image processor 1 includes an encoder 2 and a controller 3. The encoder 2 is in conformity to standards for a moving image such as MPEG-2 and MPEG-4, and performs image processing such as quantization and coding on an image signal S1 that is before compression coding, so as to output a compression-coded image signal S4. The image signal S4 is transmitted from the image processor 1 to a display device (not illustrated) via a wireless LAN or the like, and the display device displays a moving image.

The controller 3 receives an input of the image signals S1 and S4, and also an input of a signal S2A indicating a maximum allowable amount of code for one macroblock, a signal S2B indicating a target amount of code for one macroblock, and a signal S2C indicating basic information for setting a number (hereinafter referred to as a “specified number Z”) of macroblocks that constitute a unit for setting the target amount of code. The maximum allowable amount of code for one macroblock is calculated based on a maximum bit rate (for example, 18 Mbps) from the image processor 1 to the display device, a frame rate (for example, 60 fps) of the moving image, and a total number (for example, 3600) of macroblocks within one frame. Similarly, the target amount of code for one macroblock is calculated based on a target bit rate (for example, 14 Mbps) from the image processor 1 to the display device, the frame rate of the moving image, and the total number of macroblocks within one frame.

When the image processor 1 is used for a teleconferencing system, for example, basic information indicating a zoom factor of a camera is inputted as the signal S2C. In taking a wide-angle view (that is, with a low zoom factor) of many people attending a conference, an image quality is required to be high to identify each person in the image. Thus the controller 3 sets the specified number Z of macroblocks at a relatively large value. For example, the specified number Z is set at a GOP unit or a frame unit. With a specified number Z set at a large value, though a delay amount is increased, an average image quality is improved. That is, the controller 3 sets the specified number Z at a relatively large value in image reproduction under a loose delay limit, so as to give precedence to the image quality over the delay amount.

In contrast, in taking a telescope view (that is, with a high zoom factor) of one person making a speech, a delay amount is required to be little to synchronize the movements of the speaker's lips with the sound. Thus the controller 3 sets the specified number Z of macroblocks at a relatively small value. For example, the specified number Z is set at ⅓ of a total number of macroblocks within one frame. With a specified number Z set at a small value, though an average image quality is degraded, a delay amount is reduced. That is, the controller 3 sets the specified number Z at a relatively small value in image reproduction under a rigid delay limit, so as to give precedence to the delay amount over the image quality.

It should be noted that the controller 3 may dynamically change the specified number Z within a range of, for example, one or larger and smaller than a GOP unit, in accordance with the zoom factor given by the signal S2C. The specified number Z is not limited to a GOP unit, but may be set at an arbitrary number of macroblocks (that is, an arbitrary time). Moreover, the image processor 1 may be used for purposes other than a teleconferencing system.

The controller 3 controls the quantization parameter for quantization in the encoder 2 with a control signal S3, based on these signals S1, S2A to S2C, and S4.

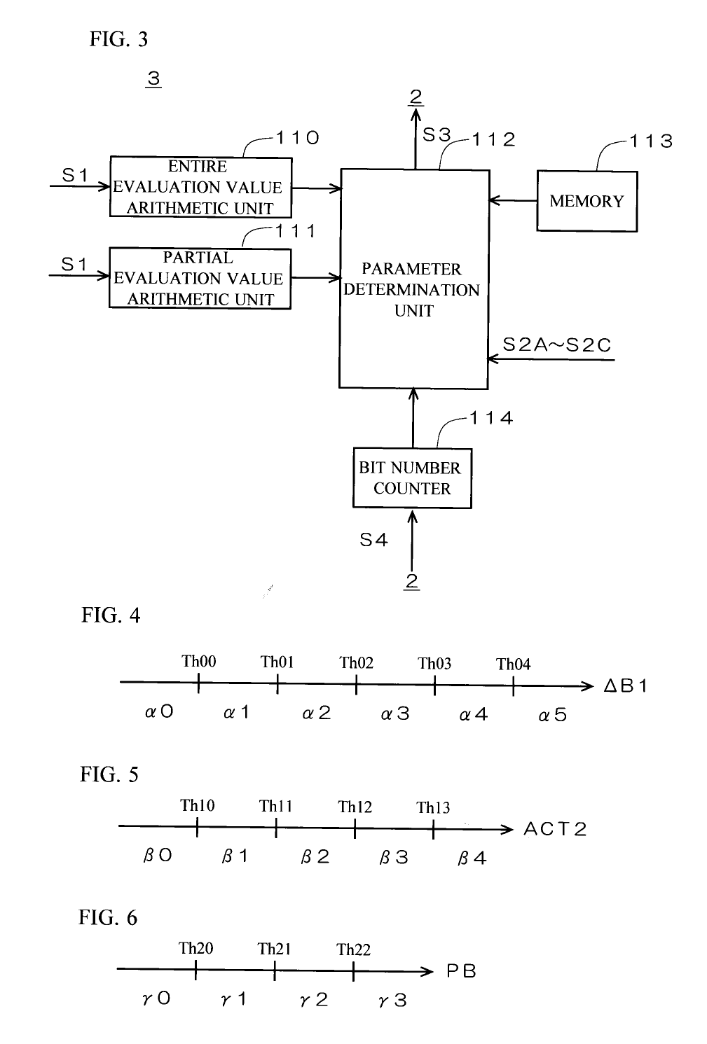

FIG. 3 is a block diagram illustrating an example of the configuration of the controller 3 illustrated in FIG. 2. As illustrated in FIG. 3, the controller 3 includes an entire evaluation value arithmetic unit 110, a partial evaluation value arithmetic unit 111, a parameter determination unit 112, a memory 113, and a bit number counter 114. The image signal S1 is inputted to the entire evaluation value arithmetic unit 110 and the partial evaluation value arithmetic unit 111. The signals S2A to S2C are inputted to the parameter determination unit 112. The image signal S4 is inputted to the bit number counter 114. The control signal S3 is outputted from the parameter determination unit 112.

The entire evaluation value arithmetic unit 110 calculates an activity evaluation value act1 (details are described below) of the entire area of a currently target macroblock, based on the image signal S1. The partial evaluation value arithmetic unit 111 calculates a minimum act2 (details are described below) of activity evaluation values of multiple partial areas of the currently target macroblock, based on the image signal S1. Stored in the memory 113 is data such as below-described various thresholds and constant values. The bit number counter 114 obtains a generated amount of code based on the image signal S4.

The operation of the image processor 1 according to the present embodiment is described below. The parameter determination unit 112 determines a quantization parameter QP1 of a currently target macroblock as an increase or decrease QP3 from a reference value QP2. That is, the parameter determination unit 112 computes QP1=QP2+QP3 to obtain the quantization parameter QP1.

The parameter determination unit 112 uses an average of quantization parameters of a specified number Z of macroblocks traced back from the currently target macroblock as the reference value QP2. For the macroblock at the forefront, a predetermined constant value is used as the reference value QP2. When a total number of processed macroblocks is fewer than the specified number Z, an average of quantization parameters of the processed macroblocks is used as the reference value QP2.

The parameter determination unit 112 also computes QP3=QP3A+QP3B+QP3C to obtain the increase or decrease QP3.

Specifically, the parameter determination unit 112 determines the increase or decrease QP3A, based on a difference between a target amount of code for the specified number Z of macroblocks and an amount of code generated for the specified number Z of macroblocks processed immediately before (ΔB1=generated amount of code−target amount of code). FIG. 4 is a diagram illustrating an example of how the increase or decrease QP3A is determined. In this example, the parameter determination unit 112 sets the specified number Z at 80 (which is equivalent of one macroblock line). When the difference ΔB1 is smaller than a threshold Th00 (for example, −1000 bits), the increase or decrease QP3A is set at a value α0 (for example, −4). When the difference ΔB1 is equal to or larger than the threshold Th00 and smaller than a threshold Th01 (for example, −500 bits), the increase or decrease QP3A is set at a value α1 (for example, −2). When the difference ΔB1 is equal to or larger than the threshold Th01 and smaller than a threshold Th02 (for example, 0 bit), the increase or decrease QP3A is set at a value α2 (for example, −1). When the difference ΔB1 is equal to or larger than the threshold Th02 and smaller than a threshold Th03 (for example, 500 bit), the increase or decrease QP3A is set at a value α3 (for example, 1). When difference ΔB1 is equal to or larger than the threshold Th03 and smaller than a threshold Th04 (for example, 1000 bits), the increase or decrease QP3A is set at a value α4 (for example, 2). When the difference ΔB1 is equal to or larger than the threshold Th04, the increase or decrease QP3A is set at a value α5 (for example, 4).

The parameter determination unit 112 determines the increase or decrease QP3B, based on the minimum (act2) of the activity evaluation values of the four side areas (that is, 4 pixels in column×16 pixels in row of an area including the upper side, 4 pixels in column×16 pixels in row of an area including the lower side, 16 pixels in column×4 pixels in row of an area including the left side, and 16 pixels in column×4 pixels in row of an area including the right side) of the currently target macroblock. FIG. 5 is a diagram illustrating an example of how the increase or decrease QP3B is determined. When the minimum act2 is smaller than a threshold Th10 (for example, 2), the increase or decrease QP3B is set at a value β0 (for example, −4). When the minimum act2 is equal to or larger than the threshold Th10 and smaller than a threshold Th11 (for example, 5), the increase or decrease QP3B is set at a value β1 (for example, −2). When the minimum act2 is equal to or larger than the threshold Th11 and smaller than a threshold Th12 (for example, 10) the increase or decrease QP3B is set at a value β2 (for example, 0). When the minimum act2 is equal to or larger than the threshold Th12 and smaller than a threshold Th13 (for example, 30), the increase or decrease QP3B is set at a value β3 (for example, 2). When the minimum act2 is equal to or larger than the threshold Th13, the increase or decrease QP3B is set at a value β4 (for example, 4). The activity evaluation value is an index (pixel information) which indicates variability in pixel values within a macroblock, obtained by, for example, dividing a sum of absolute differences between an average luminance value and luminance values of each pixel in the macroblock by the number of pixels within the macroblock.

The parameter determination unit 112 determines the increase or decrease QP3C, based on a generated amount of code (PB) of a previously processed macroblock. FIG. 6 is a diagram illustrating an example of how the increase or decrease QP3C is determined. When the generated amount of code PB is less than a threshold Th20 (for example, ½ of the target amount of code for one macroblock), the increase or decrease QP3C is set at a value γ0 (for example, −2). When the generated amount of code PB is equal to or more than the threshold Th20 and less than a threshold Th21 (for example, the target amount of code), the increase or decrease QP3C is set at a value γ1 (for example, −1). When the generated amount of code PB is equal to or more than the threshold Th21 and less than a threshold Th22 (for example, 3/2 of the target amount of code), the increase or decrease QP3C is set at a value γ2 (for example, 1). When the generated amount of code PB is equal to or more than the threshold Th22, the increase or decrease QP3C is set at a value γ3 (for example, 2).

As described above, the parameter determination unit 112 determines the quantization parameter QP1 of the currently target macroblock as the increase or decrease QP3 from the reference value QP2. In increasing the quantization parameter of the currently target macroblock from that of the previously processed macroblock, the parameter determination unit 112 employs a predetermined value K1 as the reference value QP2, if the reference value QP2 is smaller than the predetermined value K1. Similarly, in decreasing the quantization parameter of the currently target macroblock from that of the previously processed macroblock, the parameter determination unit 112 employs a predetermined value K2 as the reference value QP2, if the reference value QP2 is larger than the predetermined value K2.

The predetermined values K1 and K2 are set at a different value, depending on the activity evaluation value (act1) of the entire area of the currently target macroblock. The predetermined value K1 is set, for example, at 20 if the activity evaluation value act1 is smaller than 5, at 25 if equal to or larger than 5 and smaller than 10, and at 30 if equal to or larger than 10, respectively. The predetermined value K2 is set, for example, at 25 if the activity evaluation value act1 is smaller than 5, and at 51 if equal to or larger than 5.

Furthermore, if the amount of code generated for the specified number Z of macroblocks processed immediately before exceeds a predetermined threshold to be set depending on the maximum allowable amount of code (for example, 98% of the maximum allowable amount of code), the parameter determination unit 112 does not determine the quantization parameter in accordance with the above algorithm, but performs a predetermined exceptional processing. Specifically, the parameter determination unit 112 sets the quantization parameter of the currently target macroblock at a value obtained by adding a constant value (for example, 2) to the quantization parameter of the previously processed macroblock. The exceptional processing continues until the generated amount of code gets equal to or less than the threshold.

As described above, in the image processor 1 according to the present embodiment, the controller 3 determines the quantization parameter QP1 of the currently target macroblock, based on the difference ΔB1 between the target amount of code for the specified number Z of macroblocks and the amount of code generated for a predetermined number (the specified number Z in the present embodiment) of macroblocks processed immediately before. Thus the controller 3 variably sets the specified number Z. Consequently, in image reproduction under a rigid delay limit, the controller 3 sets the specified number Z at a relatively small value, so as to give precedence to the delay amount over the image quality. In image reproduction under a loose delay limit, the controller 3 sets the specified number Z at a relatively large value, so as to give precedence to the image quality over the delay amount. As a result, adequate adjustment of the image quality and the delay amount depending on conditions of image reproduction is achieved.

Also in the image processor 1 according to the present embodiment, the controller 3 determines the quantization parameter QP1 of the currently target macroblock as the increase or decrease QP3 from the reference value QP2. Furthermore, the controller 3 determines the increase or decrease QP3 based on the difference ΔB1 between the target amount of code for the specified number Z of macroblocks and the amount of code generated for the specified number Z of macroblocks processed immediately before. In this way, determining the increase or decrease QP3 based on the difference ΔB1 between the target amount of code for the specified number Z of macroblocks and the amount of code generated for the specified number Z of macroblocks processed immediately before achieves adequate determination of the quantization parameter QP1 of the currently target macroblock depending on conditions of image reproduction.

Also in the image processor 1 according to the present embodiment, the controller 3 sets the quantization parameter of the currently target macroblock at a value obtained by adding a constant value to the quantization parameter of the previously processed macroblock, if the amount of code generated for the specified number Z of macroblocks processed immediately before exceeds a predetermined threshold to be set depending on the maximum allowable amount of code. In this way, exceptional processing to forcibly set the quantization parameter at a larger value when the generated amount of code exceeds the threshold helps to prevent the generated amount of code from exceeding the maximum allowable amount of code.

### Embodiment 2

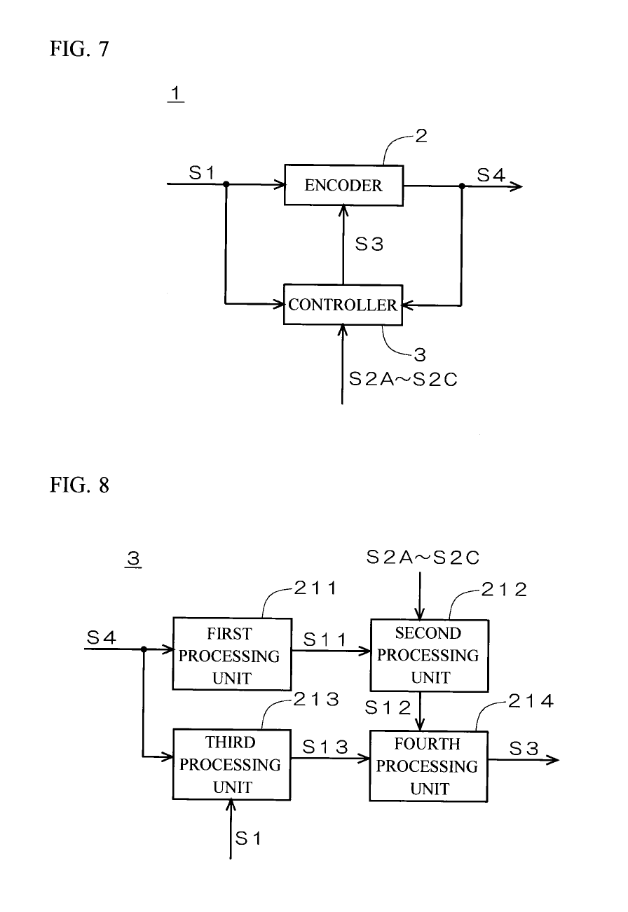

FIG. 7 is a block diagram illustrating a configuration of an image processor 1 according to Embodiment 2 of the present invention. As illustrated in FIG. 7, the image processor 1 includes an encoder 2 and a controller 3. The encoder 2 is in conformity to standards for a moving image such as MPEG-2, MPEG-4, and H.264, and performs image processing such as quantization and coding on an image signal S1 that is before compression coding, so as to output a compression-coded image signal S4. The image signal S4 is transmitted from the image processor 1 to a display device (not illustrated) via a wireless LAN or the like, and the display device displays a moving image.

Similar to the above Embodiment 1, the controller 3 receives an input of image signals S1 and S4, and also an input of a signal S2A indicating a maximum allowable amount of code for one macroblock, a signal S2B indicating a target amount of code for one macroblock, and a signal S2C indicating basic information for setting a number (specified number Z) of macroblocks that constitute a unit for setting the target amount of code. The maximum allowable amount of code for one macroblock is calculated based on a maximum bit rate (for example, 9 Mbps) from the image processor 1 to the display device, a frame rate (for example, 60 fps) of the moving image, and a total number (for example, 3600) of macroblocks within one frame. Similarly, the target amount of code for one macroblock is calculated based on a target bit rate (for example, 8.1 Mbps) from the image processor 1 to the display device, the frame rate of the moving image, and the total number of macroblocks within one frame. Furthermore, similar to the above Embodiment 1, when the image processor 1 is used for a teleconferencing system, for example, basic information indicating a zoom factor of a camera is inputted to the controller 3 as the signal S2C. Similar to the above Embodiment 1, the controller 3 sets the specified number Z at a relatively large value in image reproduction under a loose delay limit, so as to give precedence to the image quality over the delay amount, while setting the specified number Z at a relatively small value in image reproduction under a rigid delay limit, so as to give precedence to the delay amount over the image quality.

The controller 3 controls the quantization parameter for quantization in the encoder 2 with a control signal S3, based on the signals S1, S2A to S2C, and S4. In the image processor 1 according to the present embodiment, the quantization parameter is controlled so that an amount of code generated for the specified number Z (Z) of macroblocks equivalent of an allowable transit delay does not exceed a maximum allowable amount of code for the specified number Z of macroblocks.

FIG. 8 is a block diagram illustrating an example of the configuration of the controller 3 illustrated in FIG. 7. As illustrated in relation of connection in FIG. 8, the controller 3 includes a first processing unit 211, a second processing unit 212, a third processing unit 213, and a fourth processing unit 214.

The first processing unit 211 obtains a generated amount of code used for Y macroblocks processed immediately before, based on the image signal S4. The obtained generated amount of code is inputted as a signal S11 from the first processing unit 211 to the second processing unit 212.

The second processing unit 212 obtains a target amount of code for the specified number Z of macroblocks, based on the signals S2A to S2C. The second processing unit 212 also obtains an allowable amount of code available for N macroblocks (for example, 80 macroblocks included in one macroblock line starting with a currently target macroblock) to be processed immediately afterward, based on the obtained target amount of code and the generated amount of code for Y macroblocks inputted from the first processing unit 211. The obtained allowable amount of code is inputted as a signal S12 from the second processing unit 212 to the fourth processing unit 214.

If the number (Y) of macroblocks for which the generated amount of code has already been obtained is equal to or more than a value obtained by reducing the number (N) of macroblocks for which an amount of code to be generated can be expected from the number (Z) of macroblocks equivalent of the allowable transit delay (that is, if Y≧Z−N is met), the second processing unit 212 determines a value obtained by reducing a generated amount of code used for immediately preceding Z−N macroblocks from the target amount of code for Z macroblocks is an allowable amount of code available for N macroblocks to be processed immediately afterward. In contrast, if the number (Y) of macroblocks for which the generated amount of code has already been obtained is less than a value obtained by reducing the number (N) of macroblocks for which an amount of code to be generated can be expected from the number (Z) of macroblocks equivalent of the allowable transit delay (that is, if Y<Z−N is met), the second processing unit 12 determines a value obtained by reducing a generated amount of code used for immediately preceding Y macroblocks from the target amount of code for Y+N macroblocks is an allowable amount of code available for N macroblocks to be processed immediately afterward. Thus in both of when Y≧Z−N and when Y<Z−N, an allowable amount of code is adequately obtained.

The third processing unit 213 obtains an expected amount of code expected to be used for immediately subsequent N macroblocks, based on the image signal S1 (details are described below). The obtained expected amount of code is inputted as a signal S13 from the third processing unit 213 to the fourth processing unit 214.

The fourth processing unit 214 sets a quantization parameter of the currently target macroblock, based on the allowable amount of code inputted from the second processing unit 212 and the expected amount of code inputted from the third processing unit 213 (details are described below). The quantization parameter as set is inputted as a signal S3 from the fourth processing unit 214 to the encoder 2 illustrated in FIG. 7.

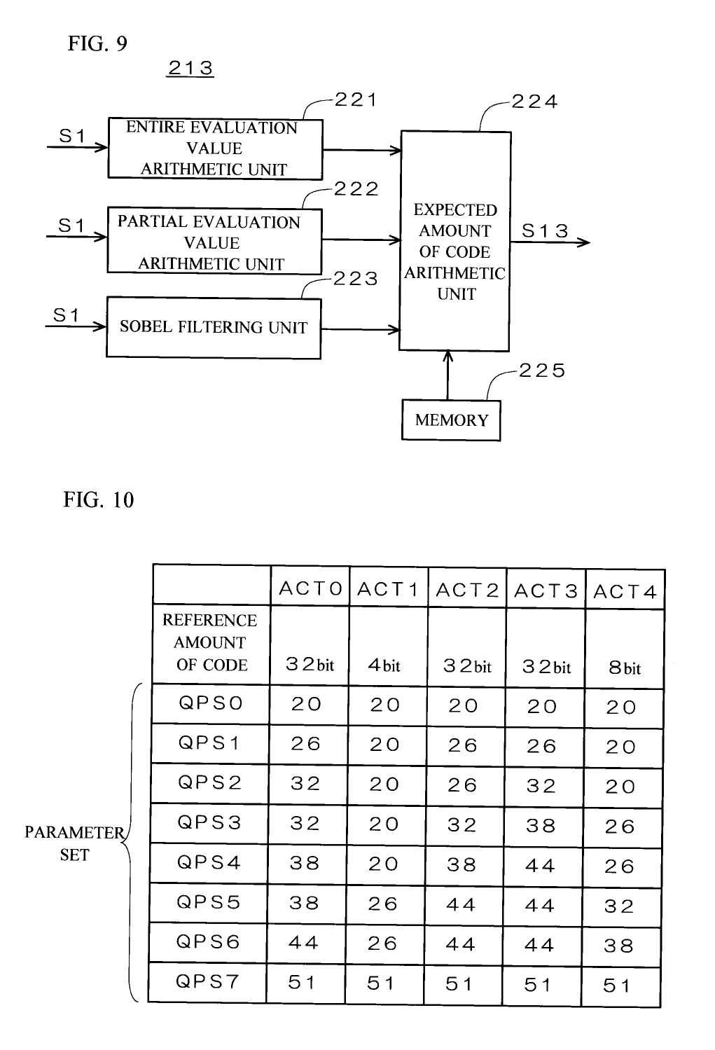

FIG. 9 is a block diagram illustrating an example of the configuration of the third processing unit 213 illustrated in FIG. 8. As illustrated in relation of connection in FIG. 9, the third processing unit 213 includes an entire evaluation value arithmetic unit 221, a partial evaluation value arithmetic unit 222, a Sobel filtering unit 223, an expected amount of code arithmetic unit 224, and a memory 225.

The entire evaluation value arithmetic unit 221 calculates an activity evaluation value act1 of the entire area of each macroblock (16 pixel in column×16 pixels in row) of the immediately subsequent N macroblocks, based on the image signal S1. The activity evaluation value is an index which indicates variability in pixel values within a macroblock, obtained by, for example, dividing a sum of absolute differences between an average luminance value and luminance values of each pixel in the macroblock by the number of pixels within the macroblock. Employing such an activity evaluation value act1 realizes an adequate expected amount of code, by estimating a small quantization parameter (that is, a large amount of code) for macroblocks having a wholly smooth attribute (that is, macroblocks where image degradation is noticeable).

The partial evaluation value arithmetic unit 222 calculates a minimum act2 of activity evaluation values of multiple partial areas of each macroblock of the immediately subsequent N macroblocks, based on the image signal S1. More specifically, activity evaluation values are calculated for each of an area of 4 pixels in column×16 pixels in row including the upper side of each macroblock, an area of 4 pixels in column×16 pixels in row including the lower side, an area of 16 pixels in column×4 pixels in row including the left side, and an area of 16 pixels in column×4 pixels in row including the right side, and a minimum act2 among them are obtained. Employing such a minimum act2 realizes an adequate expected amount of code, by estimating a large quantization parameter (that is, a small amount of code) for macroblocks having an attribute of, for example, being wholly complex, not including a character area, and not including a smooth part in a part (that is, macroblocks where image degradation is not noticeable). In contrast, for macroblocks having an attribute of, for example, being wholly complex and not including a character area, but including a smooth part in a part (that is, macroblocks where image degradation is noticeable in the smooth part), an adequate expected amount of code is realized by estimating a somewhat small quantization parameter (that is, a somewhat large amount of code).

The Sobel filtering unit 223 performs edge detection with a Sobel filter for multiple partial areas of each macroblock of the immediately subsequent N macroblocks, based on the image signal S1, and obtains a maximum Sobel of the filtering results. More specifically, edge detection is performed on an area of 4 pixels in column×16 pixels in row including the upper side of each macroblock, an area of 4 pixels in column×16 pixels in row including the lower side, an area of 16 pixels in column×4 pixels in row including the left side, and an area of 16 pixels in column×4 pixels in row including the right side, and a maximum Sobel among the filtering results is obtained. Employing such a maximum Sobel realizes an adequate expected amount of code, by estimating a moderate quantization parameter (that is, a moderate amount of code) for macroblocks having an attribute of, for example, being wholly complex and including a character area in a part (that is, macroblocks where image degradation is noticeable in the character area).

FIG. 10 is a diagram illustrating a first example of parameter sets stored in the memory 225 illustrated in FIG. 9. Parameter sets QPS0 to QPS7 each have quantization parameters being set corresponding to each of attribute values ACT0 to ACT4 of a macroblock. For example, the parameter set QPS4 has a quantization parameter of a value “38” corresponding to the attribute value ACT0, a quantization parameter of “20” corresponding to the attribute value ACT1, a quantization parameter of “38” corresponding to the attribute value ACT2, a quantization parameter of “44” corresponding to the attribute value ACT3, and a quantization parameter of “26” corresponding to the attribute value ACT4. Moreover, for example, the parameter set QPS7 has quantization parameters of “51” corresponding to the attribute values ACT0 to ACT4.

Furthermore, amounts of code supposed to be generated if the quantization parameter is set at a reference value (reference amount of code) (for example, at a maximum value “51” by the H.264 standard) are also set corresponding to the attribute values ACT0 to ACT4 of the macroblock. In this example, the reference amounts of code of 32 bits, 4 bits, 32 bits, 32 bits, and 8 bits are respectively set corresponding to the attribute values ACT0, ACT1, ACT2, ACT3, and ACT4. Adequately setting reference amounts of code achieves adequate expected amounts of code for each of the multiple parameter sets QPS0 to QPS7.

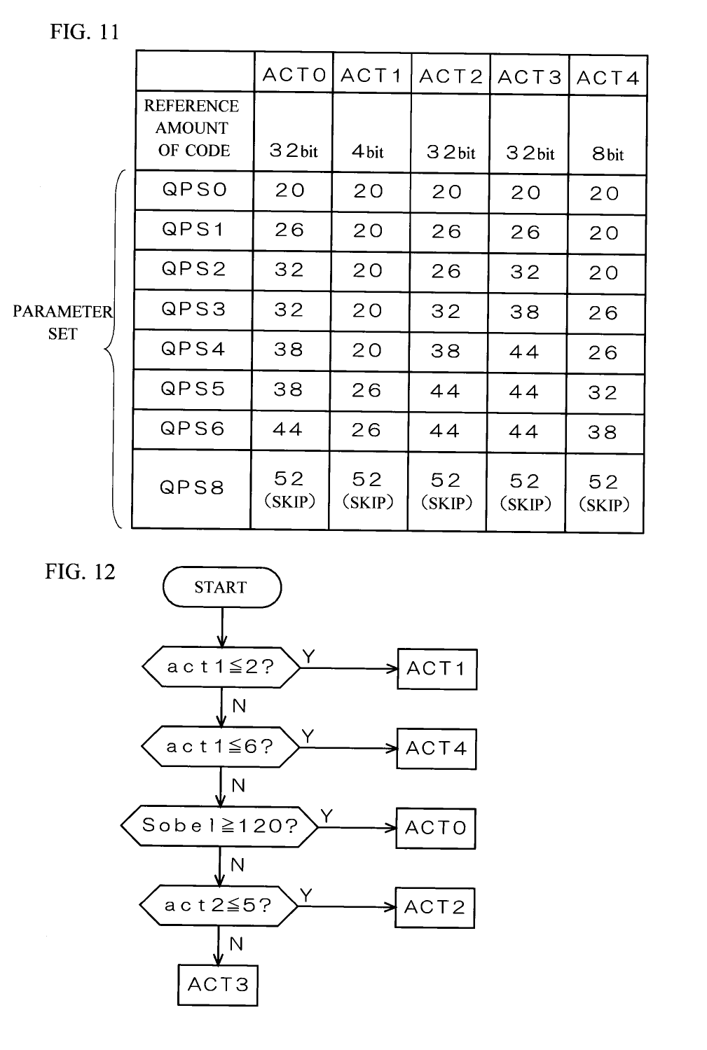

FIG. 11 is a diagram illustrating a second example of the parameter sets stored in the memory 225 illustrated in FIG. 9. A parameter set QPS8 is defined in place of the parameter set QPS7 illustrated in FIG. 10. The parameter set QPS8 has quantization parameters of “52” corresponding to the attribute values ACT0 to ACT4. The quantization parameter of “52” here means skipping coding. More specifically, this means that coding is not performed on a macroblock for which the quantization parameter is set at “52”, and a value for a macroblock in the same place within an immediately preceding frame is applied for this macroblock.

Referring to FIG. 9, the expected amount of code arithmetic unit 224 obtains an expected amount of code expected to be used for immediately subsequent N macroblocks, based on the activity evaluation value act1 obtained by the entire evaluation value arithmetic unit 221, the minimum act2 obtained by the partial evaluation value arithmetic unit 222, the maximum Sobel obtained by the Sobel filtering unit 223, and the parameter sets read from the memory 225, for each of the immediately subsequent N macroblocks. The details are as follows.

The expected amount of code arithmetic unit 224 firstly determines an attribute value for each of the immediately subsequent N macroblocks. FIG. 12 is a flow chart illustrating an example of how the attribute value is determined. As illustrated in the flow chart of FIG. 12, the attribute value of each macroblock is determined to be the attribute value ACT1 if a first condition that the activity evaluation value act1 is “2” or smaller is met, the attribute value ACT4 if the first condition is not met and a second condition that the activity evaluation value act1 is “6” or smaller is met, the attribute value ACT0 if the second condition is not met and a third condition that the maximum Sobel is “120” or larger is met, the attribute value ACT2 if the third condition is not met and a fourth condition that the minimum act2 is “5” or smaller is met, and the attribute value ACT3 if the fourth condition is not met. The expected amount of code arithmetic unit 224 counts how many macroblocks having an attribute value determined to be each of the attribute values ACT0 to ACT4 are included in the immediately subsequent N macroblocks.

The expected amount of code arithmetic unit 224 next calculates total expected amounts of code of the immediately subsequent N macroblocks, for the cases when each of the parameter sets QPS0 to QPS6 is applied. As illustrated in FIGS. 10 and 11, the quantization parameters of the parameter sets QPS0 to QPS6 are set at any one of “20”, “26”, “32”, “38”, “44” and “51”. According to H.264 standard, the quantization accuracy is doubled when the quantization parameter decreases by “6”. Thus amounts of code supposed to be generated when the quantization parameter is set at “20”, “26”, “32”, “38”, “44”, and “51” are respectively 32 times, 16 times, eight times, four times, two times, and one time the reference amount of code. Thus when the immediately subsequent N macroblocks include K0, K1, K2, K3, and K4 macroblocks determined to have the attribute values ACT0, ACT1, ACT2, ACT3, and ACT4, respectively, the total expected amount of code when, for example, the parameter set QPS4 is applied is obtained by 32(bits)*4(times)*K0+4*32*K1+32*4*K2+32*2*K3+8*16*K4. The expected amount of code arithmetic unit 224 also calculates the total expected amounts of code when the other parameter sets QPS0 to QPS3, QPS5, and QPS6 are applied, in the same manner as above. Then the total expected amounts of code when each of the parameter sets QPS0 to QPS6 is applied are inputted as signal S13 to the fourth processing unit 214 illustrated in FIG. 8.

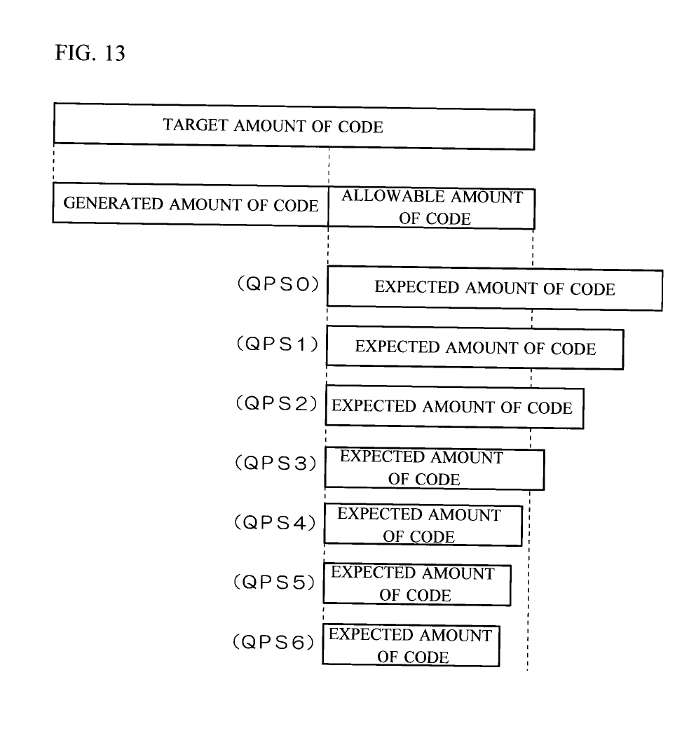

FIG. 13 is a diagram illustrating an example of how the fourth processing unit 214 selects a parameter set. The allowable amount of code of the immediately subsequent N macroblocks is obtained by reducing an amount of code generated for Z−N macroblocks processed immediately before from a target amount of code for Z macroblocks.

The fourth processing unit 214 selects a parameter set that realizes the largest expected amount of code equal to or less than the allowable amount of code, from the parameter sets QPS0 to QPS6. In the example illustrated in FIG. 13, the parameter set QPS4 is selected. Then the fourth processing unit 214 sets a quantization parameter of the currently target macroblock, based on the selected parameter set QPS4. For example, if the attribute value of the currently target macroblock is the attribute value ACT0, the quantization parameter of this macroblock is set to “38” defined at the point where QPS4 meets the ACT0 in FIG. 10 or 11. In this example, the generated amount of code is kept not larger than the target amount of code, while improving the image quality to a maximum extent.

For another example, the fourth processing unit 214 selects a parameter set that realizes the expected amount of code closest to the allowable amount of code, from the parameter sets QPS0 to QPS6. In the example illustrated in FIG. 13, the parameter set QPS3 is selected. The fourth processing unit 214 sets a quantization parameter of the currently target macroblock, based on the selected parameter set QPS3. For example, if the attribute value of the currently target macroblock is the attribute value ACT0, the quantization parameter of this macroblock is set to “32” defined at the point where QPS3 meets the ACT0 in FIG. 10 or 11. In this example, since the generated amount of code is brought close to the target amount of code, reliable code amount control is realized. It should be noted in this example that if the expected amount of code exceeds the allowable amount of code, resulting in the sum of the generated amount of code and the expected amount of code reaching, for example, 105% of the target amount of code or larger, selection of a parameter set which would cause the expected amount of code to exceed the allowable amount of code may be prohibited.

Moreover, if the parameter set QPS6 that causes the expected amount of code to be smallest is selected from the parameter sets QPS0 to QPS6 and still the expected amount of code exceeds the allowable amount of code, the fourth processing unit 214 selects the parameter set QPS7 illustrated in FIG. 10 or the parameter set PQS8 illustrated in FIG. 11. If the parameter set QPS7 is selected, the quantization parameter of the currently target macroblock is set to the maximum value according to the standard, “51”. If the parameter set QPS8 is selected, coding of the currently target macroblock is skipped. Although skipping coding results in image degradation of the macroblock, the generated amount of code is reduced by omitting coding, and thus the allowable amount of code for subsequent processing of the macroblock becomes larger.

As described above, in the image processor 1 according to the present embodiment, the controller 3 determines the quantization parameter of the currently target macroblock, based on the difference between the target amount of code for the specified number Z of macroblocks and the amount of code generated for a predetermined number (Y in the present embodiment) of macroblocks processed immediately before. Thus the controller 3 variably sets the specified number Z. Consequently, in image reproduction under a rigid delay limit, the controller 3 sets the specified number Z at a relatively small value, so as to give precedence to the delay amount over the image quality. In image reproduction under a loose delay limit, the controller 3 sets the specified number Z at a relatively large value, so as to give precedence to the image quality over the delay amount. As a result, adequate adjustment of the image quality and the delay amount depending on conditions of image reproduction is achieved.

Also in the image processor 1 according to the present embodiment, the first processing unit 211 obtains a generated amount of code used for Y macroblocks processed immediately before. The second processing unit 212 obtains an allowable amount of code available for immediately subsequent N macroblocks including the currently target macroblock, based on a target amount of code for Z macroblocks and the generated amount of code obtained by the first processing unit 211. The third processing unit 213 obtains an expected amount of code expected to be used for immediately subsequent N macroblocks. The fourth processing unit 214 determines a quantization parameter of the currently target macroblock, based on the allowable amount of code obtained by the second processing unit 212 and the expected amount of code obtained by the third processing unit 213. Determining the quantization parameter of the currently target macroblock based on the target amount of code for the specified number Z of macroblocks, as described above, achieves adequate determination of the quantization parameter of the currently target macroblock depending on conditions of image reproduction.

While the invention has been described in detail, the foregoing description is in all aspects illustrative and not restrictive. It is therefore understood that numerous modifications and variations can be devised without departing from the scope.

### EXPLANATION OF REFERENCE NUMERALS

1 image processor

2 encoder

3 controller

110, 221 entire evaluation value arithmetic unit

111, 222 partial evaluation value arithmetic unit

112 parameter determination unit

113, 225 memory

114 bit number counter

211 first processing unit

212 second processing unit

213 third processing unit

214 fourth processing unit

223 Sobel filtering unit

224 expected amount of code arithmetic unit

1. An image processor comprising:
an encoder that performs encoding including quantization on an image signal; and
a controller that controls a quantization parameter in the quantization,
wherein
the controller determines a quantization parameter of a currently target macroblock, based on a difference between a target amount of code for a specified number of macroblocks and an amount of code generated for a predetermined number of macroblocks processed immediately before, and
the controller variably sets the specified number.

2. The image processor according to claim 1, wherein
the controller
determines the quantization parameter of the currently target macroblock as an increase or decrease from a reference value, and
determines the increase or decrease, based on a difference between the target amount of code for the specified number of macroblocks and an amount of code generated for said specified number of macroblocks processed immediately before.

3. The image processor according to claim 2, wherein
the controller, if the amount of code generated for the specified number of macroblocks processed immediately before exceeds a predetermined threshold to be set depending on a maximum allowable amount of code, sets the quantization parameter of the currently target macroblock at a value obtained by adding a constant value to a quantization parameter of a previously processed macroblock.

4. The image processor according to claim 1,
the controller including
a first processing unit that obtains a generated amount of code used for a first predetermined number of immediately preceding macroblocks;
a second processing unit that obtains an allowable amount of code available for a third predetermined number of immediately subsequent macroblocks including the currently target macroblock, based on the target amount of code for a second predetermined number of macroblocks and the generated amount of code obtained by the first processing unit, the second predetermined number being the specified number;
a third processing unit that obtains an expected amount of code expected to be used for the third predetermined number of macroblocks; and
a fourth processing unit that determines the quantization parameter of the currently target macroblock, based on the allowable amount of code obtained by the second processing unit and the expected amount of code obtained by the third processing unit.
